(19) United States
(12) Patent Application Publication
(10) Pub. No.: US 2006/0062015 A1
(43) Pub. Date: Mar. 23, 2006

(54) Radiant pad for display device, backlight assembly and flat panel display device having the same

(76) Inventors: Du-Hwan Chung, Suwon-si (KR); Jong-Dae Park, Seoul (KR)

Correspondence Address: Cantor Colburn LLP, 55 Griffin Road South, Bloomfield, CT, 06002, US

(21) Appl. No.: 11/203,039

(22) Filed: Aug. 12, 2005

(30) Foreign Application Priority Data
Aug. 13, 2004 (KR) 2004-64054

(51) Int. Cl. F21V 7/04

(52) U.S. Cl. 362/600

(57) ABSTRACT

In a radiant pad, a backlight assembly and a display device, the backlight assembly has a light source, a receiving container and a heat absorbing member. The receiving container receives the light source and the heat absorbing member to absorb radiant heat emitted by the light source. The backlight assembly further includes a discharge member disposed at an exterior surface of the receiving container to discharge heat from the light source transmitted through the receiving container. Accordingly, a temperature of the backlight assembly is lowered and a temperature difference between left and right areas of the backlight assembly is also reduced, thereby improving brightness properties.

This application claims priority to Korean Patent Application No. 2004-64054, filed on Aug. 13, 2004 and all the benefits accruing therefrom under 35 U.S.C. §119, and the contents of which in its entirety are herein incorporated by reference.

### BACKGROUND OF THE INVENTION

1. Field of the Invention

The present invention relates to a backlight assembly and a display device having the backlight assembly. More particularly, the present invention relates to a radiant pad for a display device capable of improving heat discharge efficiency, a backlight assembly and a flat panel display device having the same.

2. Description of the Related Art

In a large-scale liquid crystal display device, a direct illumination type backlight assembly is adopted to improve brightness properties. A large-scale liquid crystal display device having a size over 20 inches employs a direct illumination type backlight assembly having lamps numbering from about 20 units to about 50 units.

In order to prevent an inflow of a foreign substance, the backlight assembly is almost completely isolated from an external environment. As a result, the backlight assembly may not sufficiently discharge heat generated by the lamps, and thus an inner temperature of the backlight assembly gradually increases.

In response to the inner temperature increasing, a pressure of mercury injected into the lamps may increase thereby lowering a brightness of the backlight assembly. Furthermore, injection distribution of the mercury may be not uniformly maintained due to non-uniformity of the inner temperature, so that display quality of the liquid crystal display device is deteriorated.

### BRIEF SUMMARY OF THE INVENTION

The present invention provides a radiant pad for a flat panel display device capable of improving heat discharge efficiency. The present invention also provides a backlight assembly having the radiant pad. The present invention also provides a flat panel display device having the backlight assembly.

In one aspect of the present invention, a radiant pad for a display device has a first surface and a second surface. The first surface has concavo-convex portions to enhance a surface area thereof, and the second face is adhered to an external device.

In another aspect of the present invention, a backlight assembly includes a light source, a receiving container and a heat absorbing member. The receiving container receives the light source and the heat absorbing member is disposed inside the receiving container to absorb radiant heat emitted by the light source. The backlight assembly further includes a discharge member disposed at an exterior surface of the receiving container to discharge heat from the light source transmitted through the receiving container. The heat absorbing member and the discharge member are disposed at a position corresponding to a position of an inverter.

In still another aspect of the present invention, a display device includes a backlight assembly and a display assembly. The backlight assembly has a light source emitting light, a heat absorbing member absorbing radiant heat emitted by the light source and a heat discharge member externally discharging the absorbed radiant heat. The display assembly displays images using light from the backlight assembly.

The flat panel display device further includes a receiving container receiving the light source. The heat absorbing member is disposed inside the receiving container. The heat discharge member is adhered to an exterior surface of the receiving container. The heat absorbing member and the heat discharge member are located at a position corresponding to a position of an inverter.

Accordingly, a temperature of the backlight assembly is lowered and a temperature difference between left and right areas of the backlight assembly is also reduced, thereby improving brightness properties.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view showing a backlight assembly according to an exemplary embodiment of the present invention;

FIG. 2 is an exploded perspective view showing a backlight assembly according to another exemplary embodiment of the present invention;

FIG. 3 is a schematic view illustrating a method of treating a surface of a radiant pad by an anodizing method according to an exemplary embodiment of the present invention;

FIG. 4 is a perspective view showing a surface of aluminum surface-treated by the anodizing method of FIG. 3;

FIG. 5 is a schematic view illustrating heat discharge efficiency of the backlight assembly using a radiant pad of FIG. 1;

FIGS. 6A and 6B are plane views showing an ambient temperature of a backlight assembly due to the heat discharge efficiency as described referring to FIG. 5;

FIG. 7 is an exploded perspective view showing a liquid crystal display device according to an exemplary embodiment of the present invention;

FIG. 8 is an exploded perspective view showing a backlight assembly according to an exemplary embodiment of the present invention;

FIG. 9 is an exploded perspective view showing a backlight assembly according to another exemplary embodiment of the present invention;

FIG. 10 is an exploded perspective view showing a backlight assembly according to another exemplary embodiment of the present invention;

FIG. 11 is an exploded perspective view showing a liquid crystal display device according to an exemplary embodiment of the present invention;

FIG. 12 is an exploded perspective view showing a backlight assembly according to an exemplary embodiment of the present invention;

FIG. 13 is an exploded perspective view showing a backlight assembly according to another exemplary embodiment of the present invention;

FIG. 14 is an exploded perspective view showing a backlight assembly according to yet another exemplary embodiment of the present invention; and

FIG. 15 is an exploded perspective view showing a liquid crystal display device according to an exemplary embodiment of the present invention.

### DETAILED DESCRIPTION OF THE INVENTION

Hereinafter, exemplary embodiments of the present invention will be explained in detail with reference to the accompanying drawings.

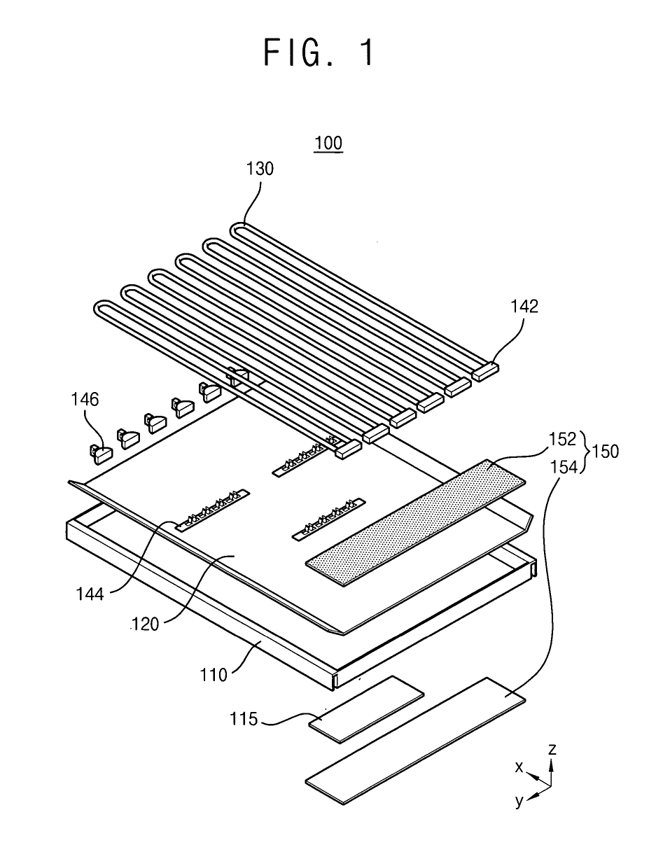

FIG. 1 is an exploded perspective view showing a backlight assembly according to an exemplary embodiment of the present invention.

Referring to FIG. 1, a backlight assembly 100 includes a bottom chassis 110, a reflecting plate 120, a lamp 130, a lamp guider and a radiant pad 150.

The bottom chassis 110 has a bottom plate and sidewalls extended from the bottom plate so as to provide a receiving space. Thus, the bottom chassis 110 is a receiving container to receive the lamp 130 and the reflecting plate 120. An inverter 115 is disposed at a face of the bottom plate of the bottom chassis 110 that is opposite of the reflecting plate 120. In other words, the inverter 115 is disposed at an exterior surface of the bottom chassis 110.

The reflecting plate 120 is disposed in the receiving space of the bottom chassis 110 and reflects light emitted by the lamp 130. In FIG. 1, the reflecting plate 120 is shown having a flat shape, however the reflecting plate 120 may have a non-flat shape. The reflecting plate 120 may be removed from the backlight assembly 100 if a material having a superior reflectance is coated over the bottom plate of the bottom chassis 110.

In an exemplary embodiment, the backlight assembly 100 includes a plurality of lamps 130 extended in an x-direction and arranged in a y-direction that is substantially perpendicular to the x-direction. The lamps 130 are spaced apart from each other by a predetermined distance. The lamps 130 may be, for example, a cold cathode fluorescent lamp having a U-shape. Alternatively, the lamps 130 may have various shapes such as, for example, an I-shape, an N-shape, an M-shape, a zigzag shape and so on.

The lamp guider has a first lamp holder 142, a second holder 144 and a lamp supporter 146 so as to uniformly maintain an interval between the reflecting plate 120 and the lamps 130 while partially covering each of the lamps 130. The lamp guider penetrates the reflecting plate 120 and is coupled to the bottom chassis 110.

The radiant pad 150 includes a heat absorbing pad 152 and a heat discharge pad 154. The heat absorbing pad 152 is attached to a face of the reflecting plate 120 that is proximate to the lamps 130 to absorb radiant heat emitted by the lamps 130. The heat discharge pad 154 is attached to the exterior surface of the bottom chassis 110 to discharge radiant heat from the bottom chassis 110. The radiant pad 150 is attached to a portion of the bottom chassis 110 corresponding to a position of the inverter 115.

The heat absorbing pad 152 and the heat discharge pad 154 include a ceramic material such as aluminum oxide (Al₂O₃) or the like. The heat absorbing pad 152 and the heat discharge pad 154 have concavo-convex portions treated by an anodizing method, thereby enhancing a surface area of the heat absorbing pad 152 and heat discharge pad 154. The heat absorbing pad 152 includes a first surface making contact with air proximate to the lamps 130 and a second surface attached to the face of the reflecting plate 120 that is proximate to the lamps 130 by an adhesive. Also, the heat discharge pad 154 includes a first surface making contact with air of an external environment and a second surface attached to the external surface of the bottom chassis 110 by an adhesive.

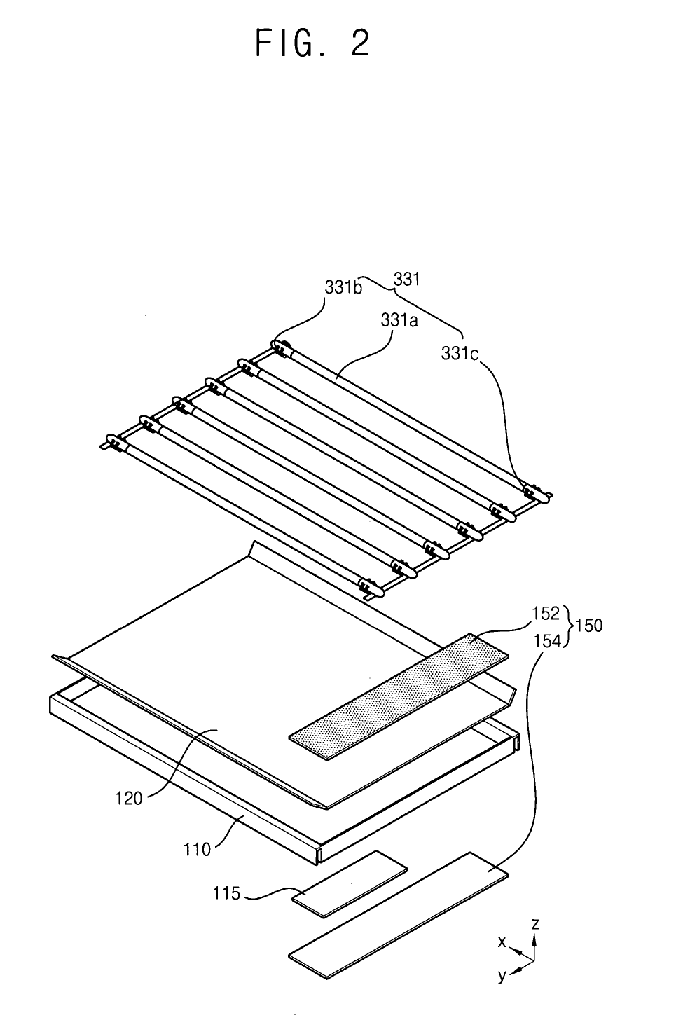

FIG. 2 is an exploded perspective view showing a backlight assembly according to an exemplary embodiment of the present invention. In FIG. 2, the same reference numerals denote the same elements in FIG. 1, and thus detailed descriptions of the same elements will be omitted.

Referring to FIG. 2, a backlight assembly includes the bottom chassis 110, the reflecting plate 120, a light source 331 and the radiant pad 150.

The bottom chassis 110 has the bottom plate and sidewalls extended from the bottom plate so as to provide the receiving space. The inverter 115 is disposed at the external surface of the bottom chassis 110 to supply a driving voltage to the light source 331. The bottom chassis 110 receives the reflecting plate 120 and the light source 331. The reflecting plate 120 reflects light emitted by the light source 331.

The light source 331 includes lamps 331a and first lamp 331b clips coupled to first ends of the lamps 331a and second lamp clips 331c coupled to second ends of the lamps 331a. The first and second lamp clips 331b and 331c are electrically connected to the inverter 115 to receive the driving voltage. In the present exemplary embodiment, the lamps 331a comprise, for example, an external electrode fluorescent lamp (EEFL).

The radiant pad 150 includes the heat absorbing pad 152 and the heat discharge pad 154. The heat absorbing pad 152 is attached to a face of the reflecting plate 120 that is proximate to the lamps 331a to absorb radiant heat emitted by the lamps 331a. The heat discharge pad 154 is attached to the external surface of the bottom chassis 110 to discharge radiant heat from the bottom chassis 110. The radiant pad 150 is attached to a portion of the bottom chassis 110 corresponding to a position of the inverter 115.

The heat absorbing pad 152 and the heat discharge pad 154 include a ceramic material such as aluminum oxide (Al₂O₃) or the like. The heat absorbing pad 152 and the heat discharge pad 154 have concavo-convex portions treated by an anodizing method, thereby enhancing a surface area of the heat absorbing pad 152 and heat discharge pad 154. The heat absorbing pad 152 includes the first surface making contact with air proximate to the lamps 331a and the second surface attached to the external surface of the reflecting plate 120 by an adhesive. Additionally, the heat discharge pad 154 includes the first surface making contact with air of the external environment and the second surface attached to the external surface of the bottom chassis 110 by an adhesive.

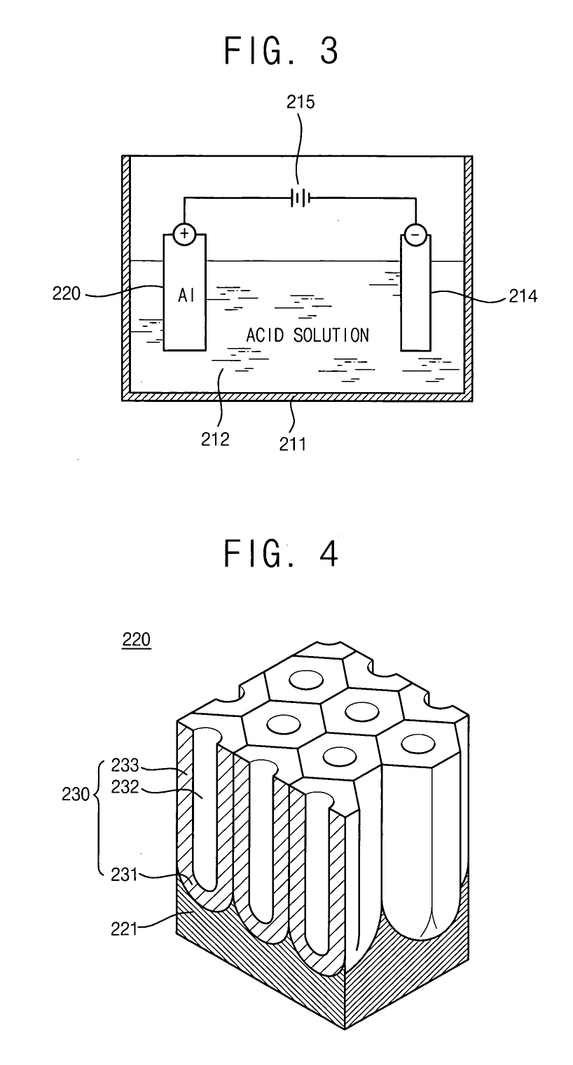

FIG. 3 is a schematic view illustrating a method of treating a surface of the radiant pad 150 by an anodizing method. The radiant pad 150 may include, for example, either the heat absorbing pad 152 or the heat discharge pad 154. The anodizing method, which is called an anodic oxidation method, is employed electrochemically to form an oxide film on the surface of the radiant pad 150 using metal materials receiving opposite polarities.

Referring to FIG. 3, an aluminum (Al) member 220 acting as an anode and a metal member 214 acting as a cathode are dipped into an acid solution 212 in a chamber 211. The aluminum member 220 and the metal member 214 are electrically connected to the anode and cathode, respectively, and a current flows between the aluminum member 220 and the metal member 214 through the acid solution. The current is driven by a voltage source 215 electrically connected to the anode and the cathode.

In other words, the current flows between the aluminum member 220 and the metal member 214 dipped into the acid solution 212 while the aluminum member 220 and the metal member 214 are electrically connected to the anode and cathode, respectively. In response to the acid solution 212 being a sulfuric acid (H₂SO₄) solution, the sulfuric acid is dissociated and hydrogen ions are generated from the metal member 214. As a result, oxygen having a negative charge and sulfuric acid ions are attached to the aluminum member 220. When aluminum anion is reacted with oxygen cation, aluminum oxide (Al₂O₃) is formed and grown on the aluminum member 220.

FIG. 4 is a perspective view showing a surface of the aluminum member surface-treated by the anodizing method of FIG. 3.

Referring to FIG. 4, an oxide layer 230 including aluminum oxide (Al₂O₃) 231 is formed and grown at a surface 221 of the aluminum member 220. When the aluminum oxide (Al₂O₃) 231 is completely grown, the aluminum oxide (Al₂O₃) 231 is dissociated by the acid solution 212. Due to a formation and dissociation of the aluminum oxide (Al₂O₃) 231, millions of defects per square inch are formed at the aluminum oxide (Al₂O₃) 231 so that pores 232 are formed at the oxide layer 230.

The pores 232 are spaced apart from each other at an equal interval, and each of the pores 232 is defined by a cell 233. The cell (or wall) 233 is grown in accordance with a current density and time.

As shown in FIG. 4, a cross-section the aluminum member 220 on which the oxide layer 230 is grown has a honeycomb structure and concavo-convex shapes in longitudinal cross-section.

When the surface of the radiant pad 150 is surface-treated by the anodizing method, the radiant pad 150 may have an enhanced surface area for absorbing and discharging radiant heat, thereby efficiently discharging heat generated by the backlight assembly 100 to the external environment.

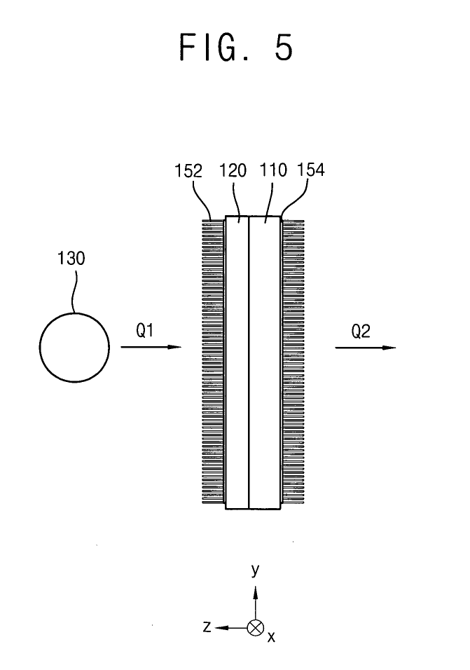

FIG. 5 is a schematic view illustrating heat discharge efficiency of a backlight assembly using the radiant pad 150 of FIG. 1.

Referring to FIG. 5, in order to explain the heat discharge efficiency, the backlight assembly includes one lamp 130 emitting radiant heat, the heat absorbing pad 152 absorbing the radiant heat, the reflecting plate 120 to which the heat absorbing pad 152 is attached, the bottom chassis 110 receiving the reflecting plate 120 and the heat discharge pad 154 discharging the absorbed radiant heat to the external environment.

In the present exemplary embodiment, the lamp 130 has a temperature of 90 degrees Celsius (=363.15K), the reflecting plate 120 and the bottom chassis 110 have temperatures of about 50 degrees Celsius (=323.15K), and a temperature of the external environment is about 25 degrees Celsius (=298.15K). The heat absorbing pad 152 and the heat discharge pad 154 each have a size of about 0.3 meters×0.2 meters, a thickness of about 0.3 t and an emissivity (e) of about 0.96≈1. Radiant heat (Q1) of the lamp 130 and discharge heat (Q2) are calculated using the following equation (1).
Q=eAsig(T⁴−a⁴) Equation (1)

In the equation (1), “T” and “a” represent absolute temperatures (K) of two surfaces facing each other, “A” represents a surface area exposed to the radiant heat, “e” represents the emissivity, “sig” represents a Stefan-Boltzmann constant (=5.67×10⁻⁸ [W/m² K²]), respectively.

The radiant heat (Q1) may be obtained by applying the emissivity (e) of the heat absorbing pad 152, the surface area (A) of the heat absorbing pad 152 exposed to the radiant heat, the temperature (T) of the lamp 130 and the temperature (a) of the reflecting plate 120 to the equation (1).

$$\begin{matrix}Q1 = e \cdot ⌊ ( 0.3 \times 0.2 ) \cdot 5.67 \times {10}^{- 8} \cdot ( {363.15}^{4} - {323.15}^{4} ) ⌋ \\ = e \cdot 22.06 [ W ] , e = 1\end{matrix} \qquad Equation ( 2 )$$

The discharge heat (Q2) may be obtained by applying the emissivity (e) of the heat absorbing pad 152, the surface area (A) of the heat absorbing pad 152 exposed to the radiant heat, the temperature (T) of the bottom chassis 110 and the temperature (a) outside the backlight assembly to the equation (1).

$$\begin{matrix}Q2 = e \cdot ⌊ ( 0.3 \times 0.2 ) \cdot 5.67 \times {10}^{- 8} \cdot ( {323.15}^{4} - {298.15}^{4} ) ⌋ \\ = e \cdot 10.22 [ W ] , e = 1\end{matrix} \qquad Equation ( 3 )$$

If the heat absorbing pad 152 and the heat discharge pad 154 are not attached, a calculation of the radiant heat (Q1′) is about 6.6 [W] and a calculation of the discharge heat (Q2′) is about 3.06 [W]. A reduction in calculated values of the radiant heat (Q1′) and the discharge heat (Q2′) occurs because an emissivity (e′) of the reflecting plate 120 and the bottom chassis 110 is about 0.3.

Thus, since the radiant heat (Q1) in a case where the heat absorbing pad 152 attached to the reflecting plate 120 is about three times higher than the radiant heat (Q1′) when the heat absorbing pad 152 is not attached to the reflecting plate 120, the radiant heat emitted from the lamp 130 is easily transmitted to the reflecting plate 120 and the bottom chassis 110. Also, the discharge heat (Q2) in a case where the heat discharge pad 154 attached to the bottom chassis 110 is about three times higher than the discharge heat (Q2′) when the heat discharge pad 154 is not attached to the bottom chassis 110, so that the radiant heat is easily discharged to the external environment.

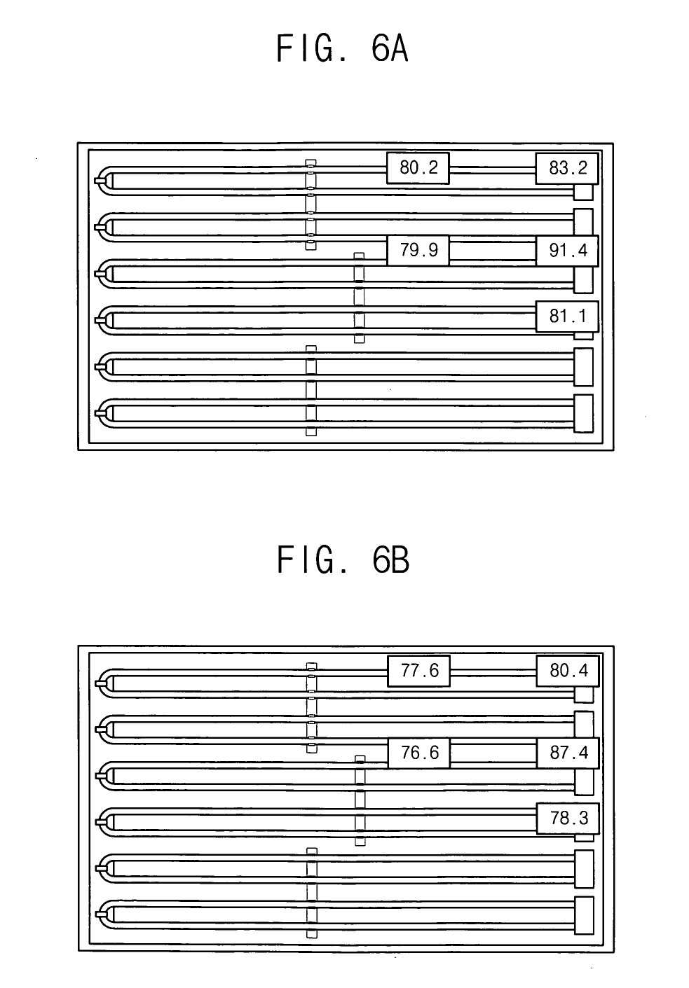

FIGS. 6A and 6B are plane views showing an ambient temperature of a backlight assembly due to the heat discharge efficiency for each case explained above referring to FIG. 5.

In the present embodiment, FIG. 6A represents the ambient temperature of a backlight assembly to which the heat absorbing pad 152 and the heat discharge pad 154 are not attached, and FIG. 6B represents the ambient temperature of the backlight assembly to which the heat absorbing pad 152 and the heat discharge pad 154 are attached.

Referring to FIGS. 6A and 6B, the ambient temperature (C) of the backlight assembly has been lowered by about 3 to about 4 degrees Celsius by attachment of the heat absorbing pad 152 and the heat discharge pad 154.

As described above, since an inner temperature of the backlight assembly is lowered, brightness properties of the backlight assembly may be improved. Also, a temperature difference between right and left sides of the backlight assembly is reduced, thereby maintaining uniformity of brightness.

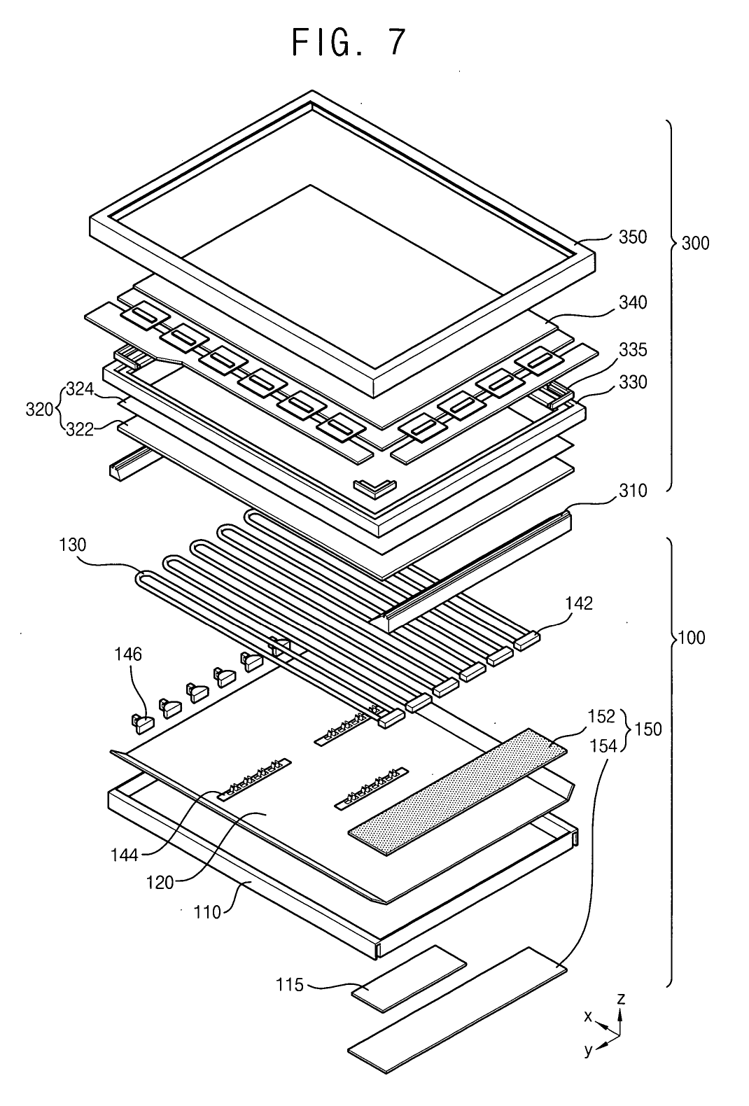

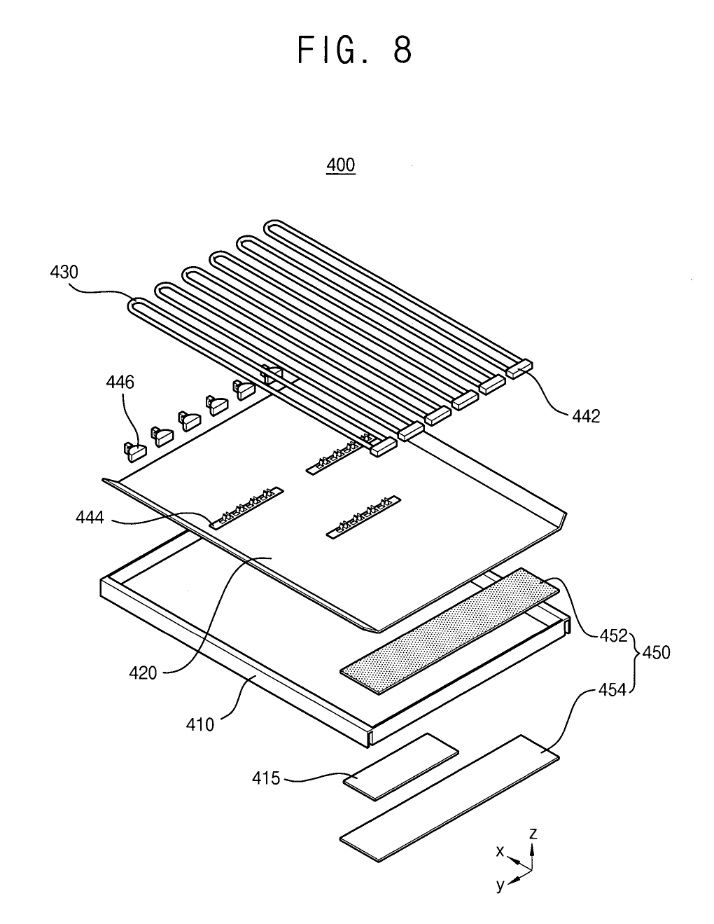

FIG. 7 is an exploded perspective view showing a liquid crystal display device according to an exemplary embodiment of the present invention.

Referring to FIG. 7, a liquid crystal display device includes the backlight assembly 100 that generates light and a display assembly 300 disposed proximate to the backlight assembly 100. The display assembly 300 receives light from the backlight assembly 100 and displays images using the light received.

The backlight assembly 100 includes the bottom chassis 110, the reflecting plate 120, the lamp 130, the lamp guider and the radiant pad 150.

The bottom chassis 110 includes the bottom plate and sidewalls extended from the bottom plate so as to provide the receiving space. The inverter 115 is disposed on the external surface of the bottom plate of the bottom chassis 110. The bottom chassis 110 receives the reflecting plate 120 and the lamp 130. The reflecting plate 120 reflects light emitted by the lamp 130.

In an exemplary embodiment, the backlight assembly 100 includes a plurality of lamps 130 extended in an x-direction and arranged in a y-direction that is substantially perpendicular to the x-direction. The lamps 130 are spaced apart from each other at a predetermined distance. The lamps 130 are, for example, a cold cathode fluorescent lamp having a U-shape. Alternatively, the lamps 130 may have various shapes such as, for example, an I-shape, an N-shape, an M-shape, a zigzag shape and so on.

The lamp guider has the first lamp holder 142, the second holder 144 and the lamp supporter 146 to uniformly maintain an interval between the reflecting plate 120 and the lamps 130 while partially covering each of the lamps 130.

The radiant pad 150 includes the heat absorbing pad 152 and the heat discharge pad 154. The heat absorbing pad 152 is attached to the face of the reflecting plate 120 that is proximate to the lamps 130 to absorb radiant heat emitted by the lamps 130. The heat discharge pad 154 is attached to the external surface of the bottom chassis 110 to discharge the radiant heat to the external environment.

The heat absorbing pad 152 and the heat discharge pad 154 include a ceramic material such as aluminum oxide (Al₂O₃) or the like. The radiant pad 150 is treated by an anodizing method so as to allow the radiant pad 150 to have a surface having an emissivity of about 1 (e≈1).

The display assembly 300 includes a side mold 310, a brightness enhancement film 320, an upper mold 330, a flat panel 340 and a top chassis 350.

The side mold 310 guides a position of the backlight assembly 100 disposed thereunder and supports the brightness enhancement film 320 disposed thereon. The brightness enhancement film 320 includes a diffusion plate 322 and optical sheets 324. The diffusion plate 322 and the optical sheets 324 are guided by a protruding portion on the side mold 310 such that the diffusion plate 322 and the optical sheets 324 are sequentially disposed on the side mold 310. The brightness enhancement film 320 receives light from the backlight assembly 100 and converts the light received to provide a light having uniform brightness distribution to the flat panel 340. The optical sheets 324 include various sheets such as, for example, a diffusion sheet, a prism sheet, a protection sheet and so on.

The upper mold 330 has a frame shape. The upper mold 330 receives the flat panel 340 guided by a panel guider 335 guiding corners of the flat panel 340. The upper mold 330 is coupled to the side mold 310 to prevent movement of the brightness enhancement film 320.

The flat panel 340 has an array substrate, a color filter substrate and a liquid crystal layer between the array substrate and the color filter substrate. The flat panel 340 receives light from the backlight assembly 100 to display images using electro-optical properties of the liquid crystal. The top chassis 350 having a frame shape is coupled to the upper mold 330 to prevent movement of the flat panel 340.

The liquid crystal display device may enhance heat discharge efficiency using the backlight assembly 100 having the radiant pad 150, thereby improving uniformity of brightness.

FIG. 8 is an exploded perspective view showing a backlight assembly according to an exemplary embodiment of the present invention.

Referring to FIG. 8, a backlight assembly 400 includes a bottom chassis 410, a reflecting plate 420, a lamp 430, a lamp guider and a radiant pad 450.

The bottom chassis 410 has a bottom plate and sidewalls extended from the bottom plate so as to provide a receiving space. An inverter 415 is disposed on an external surface of the bottom chassis 410. The bottom chassis 410 receives the reflecting plate 420 and the lamp 430.

The reflecting plate 420 is disposed in the receiving space of the bottom chassis 410 and reflects light emitted by the lamp 430. In FIG. 8, the reflecting plate 420 having a flat shape has been shown, however the reflecting plate 420 may have a non-flat shape. The reflecting plate 420 may be removed from the backlight assembly 400 if a material having a superior reflectance is coated over the bottom plate of the bottom chassis 410.

In an exemplary embodiment, the backlight assembly 400 includes a plurality of lamps 430 extended in an x-direction and arranged in a y-direction that is substantially perpendicular to the x-direction. The lamps 430 are spaced apart from each other by a predetermined distance. Each of the lamps 430 is, for example, a cold cathode fluorescent lamp having a U-shape. Alternatively, each of the lamps may have various shapes such as an I-shape, an N-shape, an M-shape, a zigzag shape or the like.

The lamp guider has a first lamp holder 442, a second lamp holder 444 and a lamp supporter 446 to uniformly maintain an interval between the reflecting plate 420 and the lamps 430 while partially covering each of the lamps 430. The lamp guider penetrates the reflecting plate 420 and is coupled to the bottom chassis 410.

The radiant pad 450 includes a heat absorbing pad 452 and a heat discharge pad 454. The heat absorbing pad 452 is attached to a face of the reflecting plate 420 that is proximate to the bottom chassis 410 to absorb radiant heat emitted by the lamps 430. The heat discharge pad 454 is attached to the external surface of the bottom chassis 410 to discharge radiant heat from the bottom chassis 410. The radiant pad 450 is attached to the bottom chassis 410 at a position corresponding to a position of the inverter 415.

The heat absorbing pad 452 and the heat discharge pad 454 include a ceramic material such as aluminum oxide (Al₂O₃) or the like. The heat absorbing pad 452 and the heat discharge pad 454 have concavo-convex portions treated by an anodizing method, thereby enhancing surface areas of the heat absorbing pad 452 and heat discharge pad 454. The heat absorbing pad 452 has a first surface making contact with a side of the reflecting sheet 420 that is opposite the lamps 430 and a second surface attached to a face of the bottom chassis 410 that is proximate to the reflecting plate 420 by an adhesive. Also, the heat discharge pad 454 has a first surface making contact with air of the external environment and a second surface attached to the external surface of the bottom chassis 410 by an adhesive.

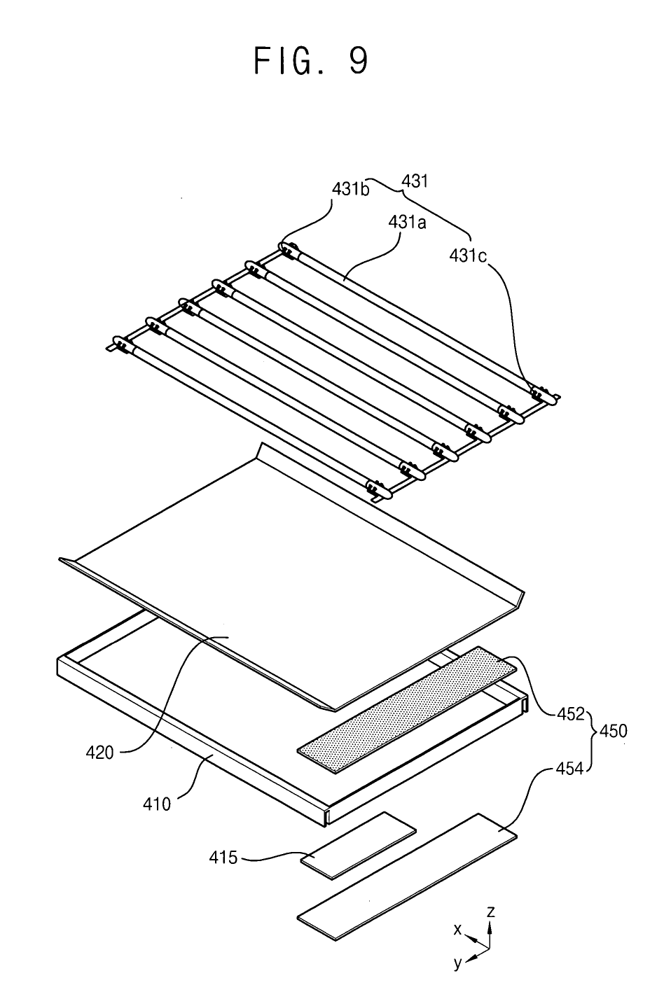

FIG. 9 is an exploded perspective view showing a backlight assembly according to another exemplary embodiment of the present invention. In FIG. 9, the same reference numerals denote the same elements in FIG. 8, and thus the detailed descriptions of the same elements will be omitted.

Referring to FIG. 9, a backlight assembly includes the bottom chassis 410, the reflecting plate 420, a light source 431 and the radiant pad 450.

The bottom chassis 410 has the bottom plate and sidewalls extended from the bottom plate so as to provide the receiving space. The inverter 415 is disposed at the external surface of the bottom chassis 410 to supply a driving voltage to the light source 431. The bottom chassis 410 receives the reflecting plate 420 and the light source 431. The reflecting plate 420 reflects light emitted by the light source 431.

The light source 431 includes lamps 431a and first lamp clips 431b coupled to first ends of the lamps 431a and second lamp clips 431c coupled to second ends of the lamps 431a. The first and second lamp clips 431b and 431c are electrically connected to the inverter 415 to receive the driving voltage. In the present exemplary embodiment, the lamps 431a comprise an external electrode fluorescent lamp (EEFL).

The radiant pad 450 includes the heat absorbing pad 452 and the heat discharge pad 454. The heat absorbing pad 452 is disposed between the bottom chassis 410 and the reflecting plate 420. The heat absorbing pad 452 is attached to a face of the bottom chassis 410 that is proximate to the reflecting plate 420 to absorb radiant heat emitted from the lamps 431a. The heat discharge pad 454 is attached to the external surface of the bottom chassis 410 to discharge radiant heat from the bottom chassis 410. The radiant pad 450 is attached to a portion of the bottom chassis 410 corresponding to a position of the inverter 415.

The heat absorbing pad 452 and the heat discharge pad 454 include a ceramic material such as aluminum oxide (Al₂O₃) or the like. The heat absorbing pad 452 and the heat discharge pad 454 have concavo-convex portions treated by an anodizing method, thereby enhancing a surface area of the heat absorbing pad 452 and heat discharge pad 454. The heat absorbing pad 452 includes the first surface making contact with the face of the reflecting plate 420 that is opposite of the lamps 431a and the second surface attached to the face of the bottom chassis 410 that is proximate to the reflecting plate 420 by an adhesive. Also, the heat discharge pad 454 includes the first surface making contact with air of the external environment and the second surface attached to the external surface of the bottom chassis 410 by an adhesive.

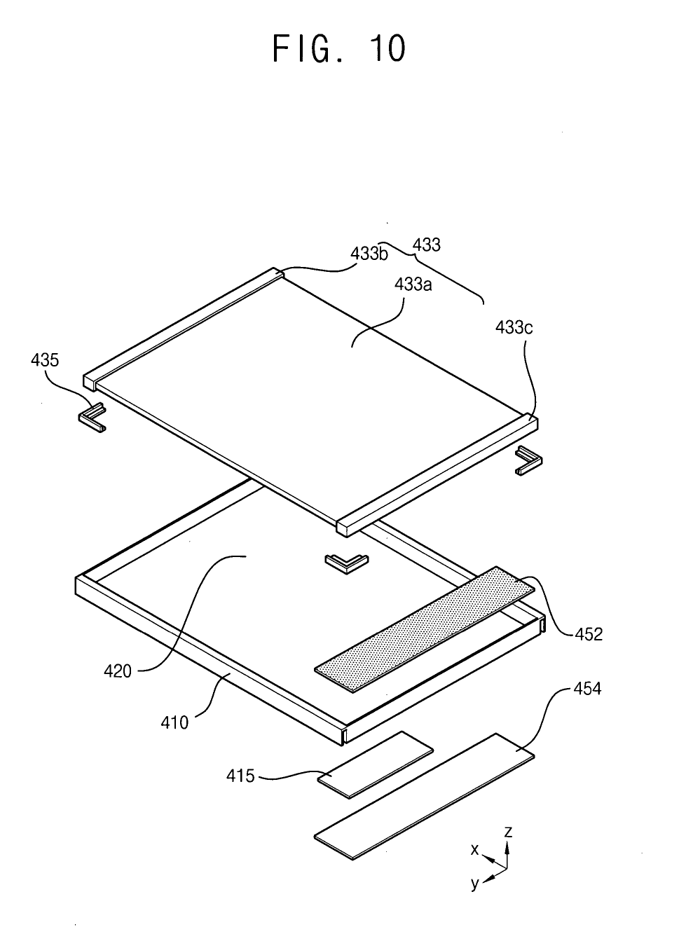

FIG. 10 is an exploded perspective view showing a backlight assembly according to another exemplary embodiment of the present invention. In FIG. 10, the same reference numerals denote the same elements in FIG. 8, and thus detailed descriptions of the same elements will be omitted.

Referring to FIG. 10, a backlight assembly includes the bottom chassis 410, a surface light source 433, a supporting member 435 and the radiant pad 450.

The bottom chassis 410 has the bottom plate and sidewalls extended from the bottom plate so as to provide the receiving space. The inverter 415 is disposed at the external surface of the bottom chassis 410 to supply a driving voltage to the surface light source 433. The bottom chassis 410 receives the surface light source 433.

The surface light source 433 includes a flat fluorescent lamp 433a, a first electrode 433b at a first end of the flat fluorescent lamp 433a to supply the driving voltage to the first end, and a second electrode 433c at a second end of the flat fluorescent lamp 433a to supply the driving voltage to the second end. The flat fluorescent lamp 433a emits light. The flat fluorescent lamp 433a generates a plasma discharge in a discharge space thereof in response to a discharge voltage provided externally and converts an ultraviolet light generated by the plasma discharge into a visible light. The discharge space of the flat fluorescent lamp 433a is divided into a plurality of sub-discharge spaces so as to uniformly emit light over the discharge space.

The supporting member 435 is disposed at a position corresponding to an end of the flat fluorescent lamp 433a. The flat fluorescent lamp 433a is spaced apart from the bottom chassis 410 by a predetermined distance by the supporting member 435 so that the flat fluorescent lamp 433a is prevented from making electrical contact with the bottom chassis 410. The supporting member 435 prevents damage to the flat fluorescent lamp 433a. The supporting member 435 may include four pieces corresponding to four corners of the flat fluorescent lamp 433a or a frame shape corresponding to sides of the flat fluorescent lamp 433a.

The radiant pad 450 includes the heat absorbing pad 452 and the heat discharge pad 454. The heat absorbing pad 452 is attached to a face of the bottom chassis 410 that is proximate to the surface light source 433 to absorb radiant heat emitted from the flat fluorescent lamp 433a. The heat discharge pad 454 is attached to the external surface of the bottom chassis 410 to discharge radiant heat from the bottom chassis 410. The radiant pad 450 is attached to a position of the bottom chassis 410 corresponding to a position of the inverter 415.

The heat absorbing pad 452 and the heat discharge pad 454 include a ceramic material such as aluminum oxide (Al₂O₃) or the like. The heat absorbing pad 452 and the heat discharge pad 454 have concavo-convex portions treated by an anodizing method, thereby enhancing a surface area of the heat absorbing pad 452 and heat discharge pad 454. The heat absorbing pad 452 has the first surface making contact with air proximate to the flat fluorescent lamp 433 and the second surface attached to the face of the bottom chassis 410 that is proximate to the surface light source 433 by an adhesive. Also, the heat discharge pad 454 has the first surface making contact with air of the external environment and the second surface attached to the external surface of the bottom chassis 410 via an adhesive.

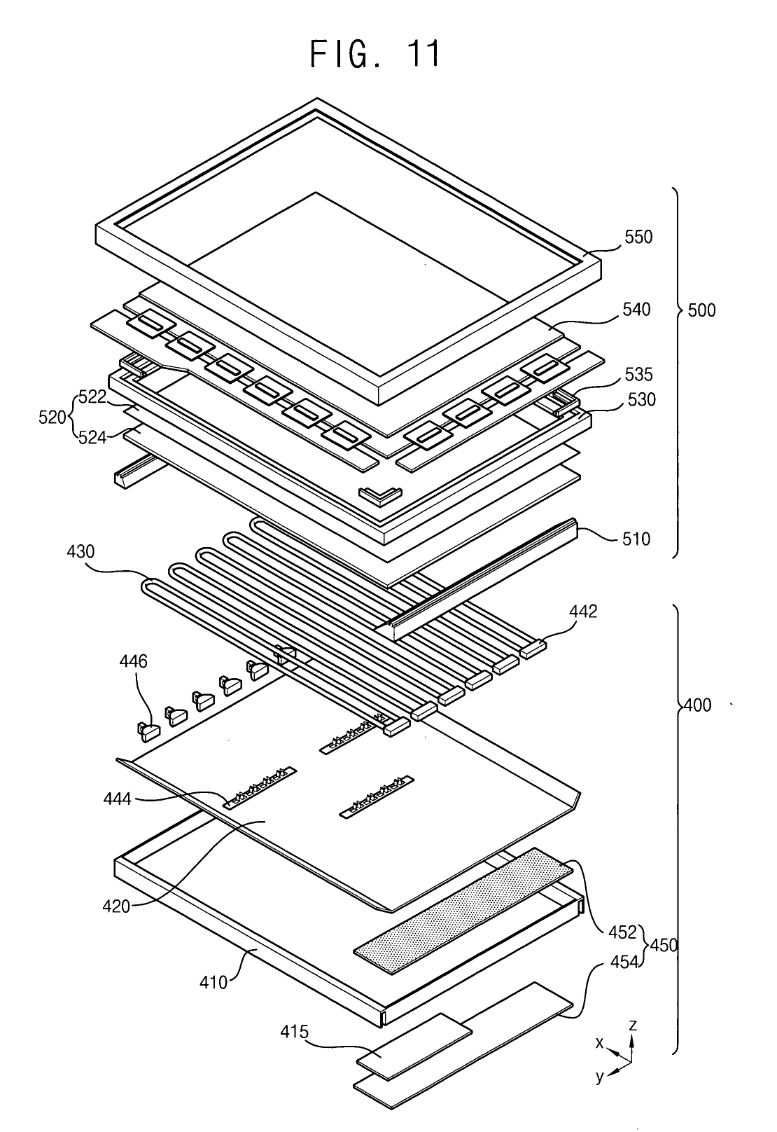

FIG. 11 is an exploded perspective view showing a liquid crystal display device according to an exemplary embodiment of the present invention.

Referring to FIG. 11, a liquid crystal display device includes a backlight assembly 400 generating light and a display assembly 500 disposed proximate to the backlight assembly 400. The display assembly 500 receives light from the backlight assembly 400 and displays images using the light received.

The backlight assembly 400 includes the bottom chassis 410, the reflecting plate 420, the lamp 430, the lamp guider and the radiant pad 450.

The bottom chassis 410 has the bottom plate and sidewalls extended from the bottom plate so as to provide the receiving space. The inverter 415 is disposed at the external surface of the bottom plate of the bottom chassis 410. The reflecting plate 420 is disposed in the receiving space of the bottom chassis 410 and reflects light emitted by the lamp 430.

In an exemplary embodiment, the backlight assembly 400 includes a plurality of lamps 430 extended in an x-direction and arranged in a y-direction that is substantially perpendicular to the x-direction.

The lamp guider includes the first lamp holder 442, the second lamp holder 444 and the lamp supporter 446 to uniformly maintain an interval between the reflecting plate 420 and the lamps 430 while partially covering each of the lamps 430.

The radiant pad 450 includes the heat absorbing pad 452 and the heat discharge pad 454. The heat absorbing pad 452 is attached to the face of the bottom chassis 410 that is proximate to the reflecting plate 420 to absorb radiant heat emitted by the lamps 430. The heat discharge pad 454 is attached to the external surface of the bottom chassis 410 to discharge the radiant heat to the external environment.

The heat absorbing pad 452 and the heat discharge pad 454 include a ceramic material such as aluminum oxide (Al₂O₃) or the like. The radiant pad 450 is treated by an anodizing method so as to allow the radiant pad 450 to have a surface having an emissivity of about 1 (e≈1).

The display assembly 500 includes a side mold 510, a brightness enhancement film 520, an upper mold 530, a flat panel 540 and a top chassis 550. The side mold 510 guides a position of the backlight assembly 400 disposed thereunder and supports the brightness enhancement film 520 disposed thereon.

The brightness enhancement film 520 includes a diffusion plate 522 and optical sheets 524. The diffusion plate 522 and the optical sheets 524 are guided into position by a stepped portion on the side mold 510 such that the diffusion plate 522 and the optical sheets 524 are sequentially disposed on the side mold 510. The brightness enhancement film 520 receives light from the backlight assembly 400 and converts the light received to provide a light having a uniform brightness distribution to the flat panel 540. The optical sheets 524 include various sheets such as a diffusion sheet, a prism sheet, a protection sheet, etc.

The upper mold 530 has a frame shape. The upper mold 530 receives the flat panel 540 guided by a panel guider 535 guiding corners of the flat panel 540. The upper mold 530 is coupled to the side mold 510 to prevent movement of the brightness enhancement film 520.

The flat panel 540 has an array substrate, a color filter substrate and a liquid crystal layer disposed between the array substrate and the color filter substrate. The flat panel 540 on the upper mold 530 receives light from the backlight assembly 400 to display images using electro-optical properties of the liquid crystal. The top chassis 550 having a frame shape is coupled to the upper mold 530 to prevent movement of the flat panel 540.

The liquid crystal display device may enhance heat discharge efficiency using the backlight assembly 400 having the radiant pad 450, thereby improving uniformity of brightness.

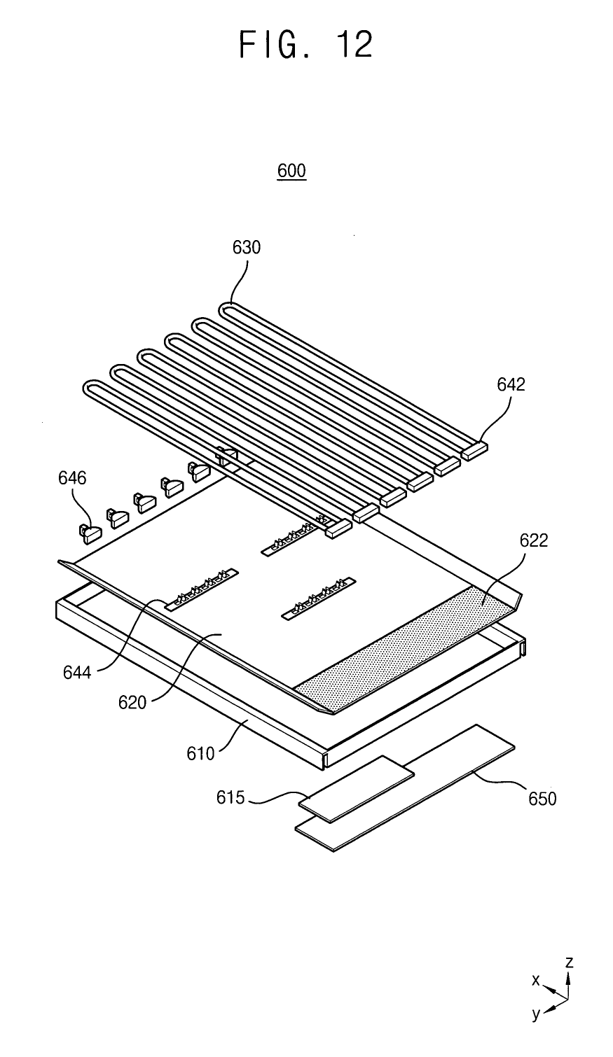

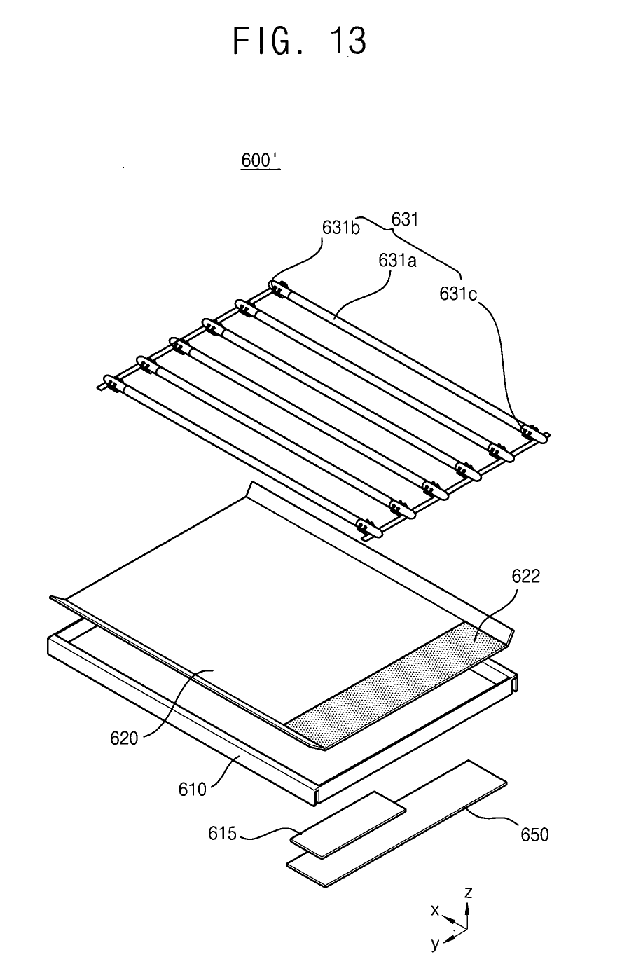

FIG. 12 is an exploded perspective view showing a backlight assembly according to an exemplary embodiment of the present invention.

Referring to FIG. 12, a backlight assembly 600 includes a bottom chassis 610, a reflecting plate 620, a lamp 630, a lamp guider and a radiant pad 650.

The bottom chassis 610 has a bottom plate and sidewalls extended from the bottom plate so as to provide a receiving space. An inverter 615 is disposed on an external surface of the bottom plate of the bottom chassis 610. The bottom chassis 610 receives the reflecting plate 620 and the lamp 630 in the receiving space. The reflecting plate 620 reflects light emitted from the lamp 630. In FIG. 12, the reflecting plate 620 is shown having a flat shape, however the reflecting plate 620 may have a non-flat shape. The reflecting plate 620 further includes an emissive pattern 622 formed on a face of the reflecting plate that is proximate to the lamp 630. The reflecting plate 620 may be formed by coating a material, such as polyethylene terephthalate (PET) having a superior reflectance over a plate.

The reflecting plate 620, over which the PET is coated, is treated by an anodizing method to form the emissive pattern 622 having concavo-convex portions, thereby enhancing a surface area of the emissive pattern 622. The emissive pattern 622 absorbs heat generated by the lamp 630. Alternatively, the PET may be coated over the bottom face of the bottom chassis 610 and used in lieu of the reflecting plate 620. When the PET coated over the bottom face of the bottom chassis 610 is used, the PET is treated by the anodizing method to form the emissive pattern 622. In the present embodiment, the emissive pattern 622 is disposed at a portion of the reflecting plate 620 corresponding to a position of the inverter 615.

The lamp 630 includes, for example, a cold cathode fluorescent lamp having a U-shape. Furthermore, the lamp 630 may have various shapes such as, for example, an I-shape, an N-shape, an M-shape, a zigzag shape, etc.

The lamp guider has a first lamp holder 642, a second lamp holder 644 and a lamp supporter 646 to uniformly maintain an interval between the reflecting plate 620 and the lamp 630 while partially covering a portion of the lamp 630. The lamp guider is coupled to the bottom chassis 610 penetrating the reflecting plate 620.

The radiant pad 650 is attached to the external surface of the bottom chassis 610 to discharge radiant heat from the bottom chassis 610. The radiant pad 650 is attached to a portion of the bottom chassis 610 corresponding to the position of the inverter 415.

The radiant pad 650 includes a ceramic material such as aluminum oxide (Al₂O₃) or the like. The radiant pad 650 has concavo-convex portions treated by the anodizing method, thereby enhancing a surface area thereof. The radiant pad 650 includes a first surface making contact with air of the external environment and a second surface attached to the external surface of the bottom chassis 610 by an adhesive.

FIG. 13 is an exploded perspective view showing a backlight assembly according to another exemplary embodiment of the present invention. In FIG. 13, the same reference numerals denote the same elements in FIG. 12, and thus the detailed descriptions of the same elements will be omitted.

Referring to FIG. 13, a backlight assembly 600′ includes the bottom chassis 610, the reflecting plate 620, a light source 631 and the radiant pad 650.

The bottom chassis 610 includes the bottom plate and sidewalls extended from the bottom plate so as to provide the receiving space. The inverter 615 is disposed on the external surface of the bottom plate of the bottom chassis 610 that is opposite of the reflecting plate 620.

The light source 631 includes lamps 631a and first lamp clips 631b coupled to first ends of the lamps 631a and second lamp clips 631c coupled to second ends of the lamps 631a. The first and second lamp clips 631b and 631c are electrically connected to the inverter 615 to receive a driving voltage. In the present embodiment, the lamps 631a comprise, for example, an external electrode fluorescent lamp (EEFL).

The reflecting plate 620 is received into the receiving space of the bottom chassis 610 and reflects light emitted by the lamp 630. The reflecting plate 620 further includes the emissive pattern 622 disposed at the face of the reflecting plate 620 that is proximate to the light source 631. The reflecting plate 620 may be formed by coating a material, such as polyethylene terephthalate (PET) having a superior reflectance over a plate. The emissive pattern 622 absorbs heat generated by the lamp 630. In the present embodiment, the emissive pattern 622 is disposed at the portion of the reflecting plate 620 corresponding to the position of the inverter 615.

The radiant pad 650 is attached to the external surface of the bottom chassis 610 to discharge radiant heat from the bottom chassis 610. The radiant pad 650 is attached to the portion of the bottom chassis 610 corresponding to the position of the inverter 615. The radiant pad 650 includes a ceramic material such as aluminum oxide (Al₂O₃) or the like. The radiant pad 650 has concavo-convex portions treated by the anodizing method, thereby enhancing a surface area thereof. The radiant pad 650 has the first surface making contact with air of the external environment and the second surface attached to the external surface of the bottom chassis 610 by an adhesive.

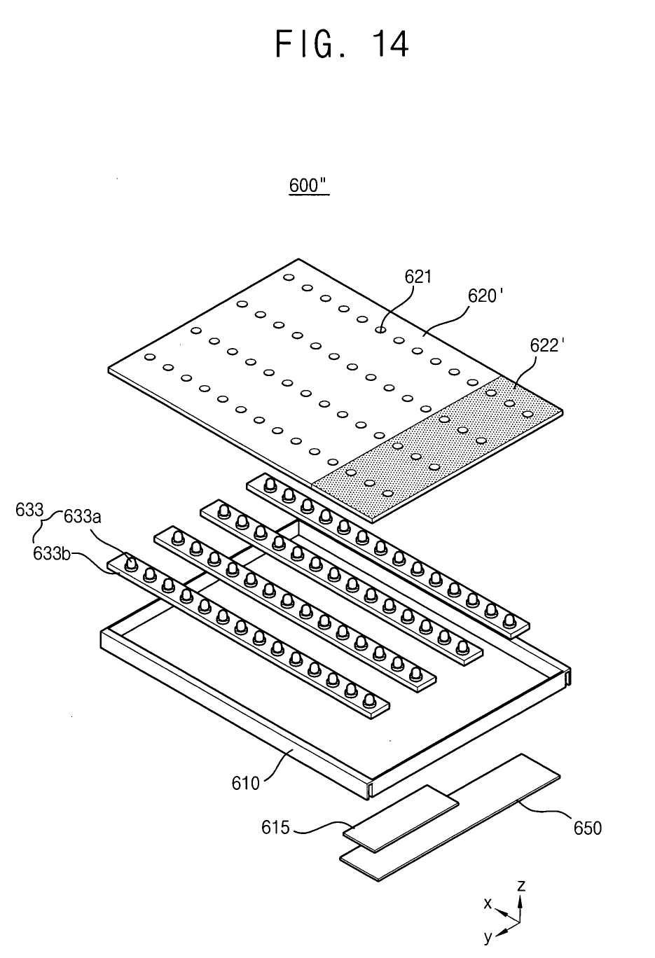

FIG. 14 is an exploded perspective view showing a backlight assembly according to yet another exemplary embodiment of the present invention. In FIG. 14, the same reference numerals denote the same elements in FIG. 12, and thus detailed descriptions of the same elements will be omitted.

Referring to FIG. 14, a backlight assembly 600″ includes the bottom chassis 610, a reflecting plate 620′, a light source 633 and the radiant pad 650.

The bottom chassis 610 has the bottom plate and sidewalls extended from the bottom plate so as to provide the receiving space. The inverter 615 is disposed at the external surface of the bottom plate of the bottom chassis 610 to supply a driving voltage to the light source 633. The bottom chassis 610 receives the light source 633 and the reflecting plate 620′ in the receiving space.

The light source 633 includes a plurality of light-emitting diodes 633a and a printed circuit board 633b. The light-emitting diodes 633a include a red light-emitting diode, a green light-emitting diode and a blue light-emitting diode so as to generate a white light.

The light-emitting diodes 633a are arranged in a longitudinal direction of the printed circuit board 633b. The light-emitting diodes 633a arranged on the printed circuit board 633b are electrically connected to the inverter 615 to receive a driving voltage.

The reflecting plate 620′ is disposed proximate to the light source 633. Holes 621 are formed through the reflecting plate 620′, and a number of the holes 621 correspond to a number of the light-emitting diodes 633a. The light-emitting diodes 633a are inserted into corresponding ones of the holes 621 so that the printed circuit board 633b is covered by the reflecting plate 620′ and the light-emitting emitting diodes 633a protrude through the holes 621. The reflecting plate 620′ reflects the light emitted by the light-emitting diodes 633a.

The reflecting plate 620′ further includes an emissive pattern 622′ on a face of the reflecting plate 620′ that is opposite of the bottom chassis 610. The reflecting plate 620′ may be formed by coating a material, such as polyethylene terephthalate (PET) having a superior reflectance over a plate. The emissive pattern 622′ absorbs heat generated from the light source 633. In the present embodiment, the emissive pattern 622′ is disposed at a portion of the reflecting plate 620′ corresponding to the position of the inverter 615.

The radiant pad 650 is attached to the external surface of the bottom chassis 610 to discharge radiant heat from the bottom chassis 610. The radiant pad 650 is attached to the portion of the bottom chassis 610 corresponding to the position of the inverter 615. The radiant pad 650 includes a ceramic material such as aluminum oxide (Al₂O₃) or the like. The radiant pad 650 has concavo-convex portions treated by the anodizing method, thereby enhancing a surface area thereof. The radiant pad 650 includes the first surface making contact with air of the external environment and the second surface attached to the external surface of the bottom chassis 610 by an adhesive.

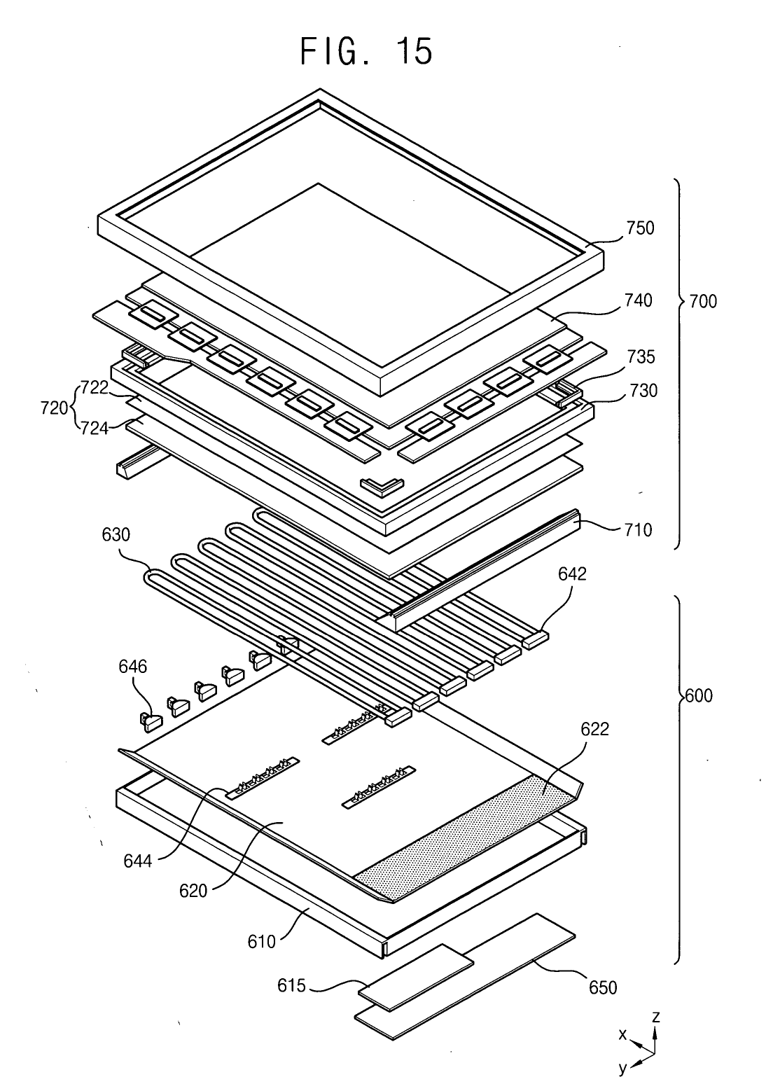

FIG. 15 is an exploded perspective view showing a liquid crystal display device according to an exemplary embodiment of the present invention.

Referring to FIG. 15, a liquid crystal display device includes the backlight assembly 600 generating light and a display assembly 700 disposed proximate to the backlight assembly 600. The display assembly 700 receives light from the backlight assembly 600 and displays images using the light received. The backlight assembly 600 includes the bottom chassis 610, the reflecting plate 620, the lamp 630, the lamp guider and the radiant pad 650.

The bottom chassis 610 includes the bottom plate and sidewalls extended from the bottom plate to provide the receiving space. The inverter 615 is disposed at the external surface of the bottom plate of the bottom chassis 610. The reflecting plate 620 is disposed in the receiving space of the bottom chassis 610 and reflects light emitted by the lamp 630.

In an exemplary embodiment the backlight assembly 600 includes a plurality of lamps 630 extended in an x-direction and arranged in a y-direction that is substantially perpendicular to the x-direction.

The lamp guider includes the first lamp holder 642, the second lamp holder 644 and the lamp supporter 646 to uniformly maintain an interval between the reflecting plate 620 and the lamps 630 while partially covering each of the lamps 630.

The radiant pad 650 is attached to the external surface of the bottom chassis 410 to discharge the radiant heat to the external environment. The radiant pad 650 includes a ceramic material such as aluminum oxide (Al₂O₃) or the like. The radiant pad 650 is treated by an anodizing method so as to allow the radiant pad 650 to have a surface having an emissivity of about 1 (e≈1).

The display assembly 700 includes a side mold 710, a brightness enhancement film 720, an upper mold 730, a flat panel 740 and a top chassis 750.

The side mold 710 guides a position of the backlight assembly 600 disposed thereunder and supports the brightness enhancement film 720 disposed thereon.

The brightness enhancement film 720 includes a diffusion plate 722 and optical sheets 724. The diffusion plate 722 and the optical sheets 724 are guided into position by a stepped portion formed on the side mold 710 such that the diffusion plate 722 and the optical sheets 724 are sequentially disposed on the side mold 710. The brightness enhancement film 720 receives light from the backlight assembly 600 and converts the light received so as to provide a light having a uniform brightness distribution to the flat panel 740. The optical sheets 724 include various sheets such as a diffusion sheet, a prism sheet, a protection sheet, etc.

The upper mold 730 has a frame shape. The upper mold 730 receives the flat panel 740 guided by a panel guider 735 guiding corners of the flat panel 740. The upper mold 730 is coupled to the side mold 710 to prevent movement of the brightness enhancement film 720.

The flat panel 740 has an array substrate, a color filter substrate and a liquid crystal layer disposed between the array substrate and the color filter substrate. The flat panel 740 on the upper mold 730 receives light from the backlight assembly 600 to display images using electro-optical properties of the liquid crystal. The top chassis 750 having a frame shape is coupled to the upper mold 730 to prevent movement of the flat panel 740.

The liquid crystal display device may enhance heat discharge efficiency using the backlight assembly 600 having the radiant pad 650, thereby improving uniformity of brightness.

According to the above, a backlight assembly has a radiant pad disposed at a portion of a bottom chassis corresponding to an inverter so as to discharge heat from a light source. Thus, a temperature of the backlight assembly is lowered and a temperature difference between left and right areas of the backlight assembly is also reduced, thereby improving brightness properties.

Furthermore, a brightness enhancement film may be removed from the flat panel display device to improve the brightness properties, so that a manufacturing cost of the flat panel display device may be reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A radiant pad for a display device comprising:
a first surface having concavo-convex portions to enhance a surface area thereof; and
a second surface adhered to an external device.

2. The radiant pad of claim 1, wherein a cross-section of each of the concavo-convex portions comprises a honeycomb structure.

3. The radiant pad of claim 1, wherein the concavo-convex portions are formed by anodizing the first surface.

4. A backlight assembly comprising:
a light source;
a receiving container to receive the light source; and
a heat absorbing member disposed inside the receiving container to absorb radiant heat emitted by the light source.

5. The backlight assembly of claim 4, further comprising a heat discharge member disposed at an exterior surface of the receiving container so as to discharge heat from the light source transmitted through the receiving container.

6. The backlight assembly of claim 5, wherein the heat discharge member is disposed at a position of the receiving container corresponding to a position of the heat absorbing member.

7. The backlight assembly of claim 5, further comprising an inverter disposed at the exterior surface of the receiving container to supply a driving voltage to the light source, and
wherein the inverter is disposed at a portion of the receiving container corresponding to a position of both the heat absorbing member and the heat discharge member.

8. The backlight assembly of claim 5, wherein the heat absorbing member and the heat discharge member each comprise a ceramic material.

9. The backlight assembly of claim 5, wherein the heat absorbing member and the heat discharge member each comprise concavo-convex portions to enhance a surface area thereof.

10. The backlight assembly of claim 9, wherein a cross-section of each of the concavo-convex portions comprises a honeycomb structure.

11. The backlight assembly of claim 9, wherein each of the concavo-convex portions is formed by a nodizing the heat absorbing member and heat the discharge member.

12. The backlight assembly of claim 4, wherein the light source comprises a light-emitting diode.

13. The backlight assembly of claim 4, wherein the light source comprises a flat fluorescent lamp.

14. The backlight assembly of claim 4, wherein the light source comprises an external electrode fluorescent lamp.

15. The backlight assembly of claim 4, wherein the light source comprises a cold cathode fluorescent lamp.

16. The backlight assembly of claim 4, further comprising a reflecting member disposed in the receiving container to reflect light emitted by the light source,
wherein the heat absorbing member is disposed between the reflection member and the receiving container.

17. The backlight assembly of claim 4, further comprising a reflecting member disposed in the receiving container to reflect light emitted by the light source,
wherein the heat absorbing member is adhered to a face of the reflecting member that is not in contact with the receiving container.

18. The backlight assembly of claim 4, wherein the heat absorbing member includes concavo-convex portions to enhance a surface area thereof.

19. The backlight assembly of claim 18, wherein a cross-section of each of the concavo-convex portions comprises a honeycomb structure.

20. The backlight assembly of claim 18, wherein the concavo-convex portions of the heat absorbing member are formed by an anodizing method.

21. The backlight assembly of claim 4, further comprising a reflecting member disposed in the receiving container,
wherein the heat absorbing member is formed at the reflecting member in an emissive pattern.

22. The backlight assembly of claim 21, wherein the emissive pattern includes concavo-convex portions to enhance a surface area thereof.

23. The backlight assembly of claim 22, wherein a cross-section of each of the concavo-convex portions comprises a honeycomb structure.

24. The backlight assembly of claim 22, wherein the concavo-convex portions of the heat absorbing member are formed by an anodizing method.

25. A display device comprising:
a backlight assembly having a light source emitting light, a heat absorbing member absorbing radiant heat emitted by the light source and a heat discharge member externally discharging the absorbed radiant heat; and
a display assembly displaying images using light from the backlight assembly.

26. The display device of claim 25, further comprising a receiving container receiving the light source,
wherein the heat absorbing member is disposed inside the receiving container, and
the heat discharge member is adhered to an exterior surface of the receiving container.

27. The display device of claim 26, wherein the heat discharge member is disposed at a portion of the receiving container corresponding to a position of the heat absorbing member.

28. The display device of claim 26, wherein the backlight assembly further comprises an inverter disposed at the exterior surface of the receiving container to supply a driving power to the light source,
wherein the heat absorbing member and the heat discharge member are each disposed at a position corresponding to a position of the inverter.

29. The display device of claim 25, wherein the heat absorbing member and the heat discharge member each comprise a ceramic material.

30. The display device of claim 25, wherein the heat absorbing member and the heat discharge member each comprise concavo-convex portions to enhance a surface area thereof.

31. The display device of claim 30, wherein a cross-section of each of the concavo-convex portions of the heat absorbing member and the heat discharge member has a honeycomb structure.

32. The display device of claim 30, wherein each of the concavo-convex portions of the heat absorbing member and the heat discharge member are formed by an anodizing method.

33. The display device of claim 25, wherein the light source comprises a light emitting diode.

34. The display device of claim 25, wherein the light source comprises a flat fluorescent lamp.

35. The display device of claim 25, wherein the light source comprises an external electrode fluorescent lamp.

36. The display device of claim 25, wherein the light source comprises a cold cathode fluorescent lamp.

37. The display device of claim 26, wherein the backlight assembly further comprises a reflecting member disposed in the receiving container to reflect light emitted by the light source,
wherein the heat absorbing member is disposed between the reflecting member and the receiving container.

38. The display device of claim 26, wherein the backlight assembly further comprises a reflecting member disposed in the receiving container to reflect light emitted by the light source,
wherein the heat absorbing member is attached to a face of the reflecting member proximate to the light source.

39. The display device of claim 25, wherein the heat absorbing member has concavo-convex portions so as to enhance a surface area thereof.

40. The display device of claim 39, wherein a cross-section of each of the concavo-convex portions has a honeycomb structure.

41. The display device of claim 39, wherein each of the concavo-convex portions of the heat absorbing member are formed by an anodizing method.

42. The display device of claim 26, wherein the backlight assembly further comprises a reflecting member disposed in the receiving container,
wherein the heat absorbing member is formed at the reflecting member in an emissive pattern.

43. The display device of claim 42, wherein the emissive pattern has concavo-convex portions so as to enhance a surface area thereof.

44. The display device of claim 43, wherein a cross-section of each of the concavo-convex portions comprises a honeycomb structure.

45. The display device of claim 43, wherein the concavo-convex portions are formed by an anodizing method.
